(19) United States
(12) Patent Application Publication
(10) Pub. No.: US 2023/0086543 A1
(43) Pub. Date: Mar. 23, 2023

(54) AIR CONDITIONING SYSTEM HAVING A DISCHARGE DEVICE FOR DISCHARGING CONDENSED WATER

(71) Applicant: TRUMA GERAETETECHNIK GMBH & CO. KG, Putzbrunn (DE)

(72) Inventors: Andreas BEYER, Putzbrunn (DE); Daniel GUMPP, Putzbrunn (DE); Stefan EIBL, Putzbrunn (DE)

(21) Appl. No.: 17/905,266

(22) PCT Filed: Feb. 22, 2021
(86) PCT No.: PCT/EP21/00019

§ 371 Date: Aug. 30, 2022

(30) Foreign Application Priority Data
Apr. 22, 2020 (DE) 10 2020 002 416.5

(51) Int. Cl. F24F 13/22

(52) U.S. Cl. CPC F24F 13/222

(57) ABSTRACT

An air-conditioning system having a discharge device (10) for discharging condensed water from the air-conditioning system, wherein the discharge device has a piping system (2) for guiding the condensed water, wherein the discharge device has a regulating element (3) and the regulating element is configured as an open channel rotatable about a longitudinal axis (4) between a first rotational position and a second rotational position. The regulating element (3) is configured and arranged such that the regulating element guides the condensed water inside the piping system (2) in the first rotational position and establishes a continuous connection between a drip-off point for the condensed water and an outer area around the air-conditioning system in the second rotational position.

### FIELD OF DISCLOSURE

The invention relates to an air-conditioning system having a discharge device for discharging condensed water from the air-conditioning system.

### BACKGROUND

Air-conditioning systems are used in many fields of application. They allow the temperature in a room to be adjusted, wherein in most cases the temperature is lowered. Furthermore, they serve to dry the room air, wherein the humidity in the air accumulates as condensed water (an alternatively used term is condensate). Air-conditioning systems are used, for example, in caravans or mobile homes—as examples of movable vehicles—where it is known to mount the actual air-conditioning system on the roof and to provide an air distributor in the room to be tempered.

The condensed water is usually collected in collecting devices in the air-conditioning system and then discharged therefrom. For this purpose, substantially two variants are used: it is known to provide openings for discharge, via which the condensed water drips onto the roof of the vehicle. It is also known to guide the condensed water via a piping system having hoses and pipes to drain points, for example near the floor.

DE 698 00 470 T2 describes, for example, a trough for collecting the condensed water which opens onto a hose section. DE 10 2004 012 871 A1 discloses a trough below the evaporator for collecting the condensed water having a hose connection in an inclined base. KR 10 2012 0 134 316 A shows a similar structure. A two-part hose for guiding the condensed water is shown in DE 11 2014 006 214 T5. The two hose sections each have one end fastened to a drainage device and the dashboard of a vehicle. A twistable coupling element is located between the two hose sections. DE 10 2014 217 174 A1 shows a roof-mounted air-conditioning system having a collection device and a line for condensed water. EP 2 112 010 A1 provides a further roof-mounted air-conditioning system having multiple discharge holes. FR 2 909 934 A1 describes a device for a vehicle including two heat exchangers by means of which the air to be tempered can be either cooled or heated. A movable flap which guides the air flow is provided for a regulation of the temperature of the air. A slot and a channel for discharging condensed water are located on one side of the flap.

Which of the two variants (i.e. direct openings or a piping system) is to be implemented depends on the type of vehicle or on individual wishes of the users or the circumstances. Therefore, the need arises to design and produce air-conditioning systems for both variants. Alternatively, components of the air-conditioning systems must be replaced or supplemented by special elements.

### SUMMARY

Therefore, the object on which the invention is based is to propose an air-conditioning system having a discharge device for the condensed water, which allows the realization of both variants of the prior art.

The invention achieves the object by an air-conditioning system having a discharge device for discharging condensed water from the air-conditioning system, wherein the discharge device has a piping system for guiding the condensed water, wherein the discharge device has a regulating element, wherein the regulating element is configured as an open channel rotatable about a longitudinal axis between a first rotational position and a second rotational position, and wherein the regulating element is configured and arranged such that the regulating element guides the condensed water inside the piping system in the first rotational position and establishes a continuous connection between a drip-off point for the condensed water and an outer area around the air-conditioning system in the second rotational position.

The device according to the invention for discharging the condensed water of the air-conditioning system has a piping system and a regulating element. Depending on the configuration, the regulating element is a part of the piping system or is coupled to the piping system with respect to the guidance of the condensed water. The regulating element is configured as an open channel which is rotatable about a longitudinal axis. More generally, the regulating element thus has at least a closed area and an open area. A rotation about the longitudinal axis changes the orientation of these areas relative to the environment, so that the closed or the open area is more likely to be involved in the guidance of the condensed water.

The regulating element has at least two defined rotational positions (an alternative designation may also be: functional settings), each of which is associated with a specific guidance of the condensed water. Depending on the configuration, the two rotational positions are associated, for example, with an engagement or they are end positions, so that further rotation about the longitudinal axis beyond the two rotational positions is not possible because, for example, stops prevent further rotation. By rotating the regulating element between the two rotational positions about the longitudinal axis of the regulating element, the condensed water is either guided through the piping system or out into the environment. Here, the drip-off point generally refers to a transition between the area of the air-conditioning system in which the condensed water is formed and the discharge device. The area for collecting the condensed water is, for example, a collection device. An advantage of the discharge device is that the regulating element allows condensed water to be drained outside the piping system. Thus, for example, if the piping system is partially clogged or frozen, the regulating element allows the condensed water to be discharged by rotating the regulating element.

Preferably, the regulating element is configured and arranged such that it can be rotated about the longitudinal axis by the mechanical intervention of a user.

In one configuration it is provided that in a plane (an alternative designation is section) perpendicular to the longitudinal axis, the channel of the regulating element opens above the position of the longitudinal axis. In other words, the channel opens in a plane above the plane in which the longitudinal axis is located. If the regulating element results in particular from a known geometric body—such as a cylinder—the configuration means that the channel encloses a larger internal volume than the volume which is quasi enclosed by the open or missing area. The open area preferably extends axially along the longitudinal axis of the regulating element.

One configuration of the discharge device provides that the regulating element has reinforcing ribs in a laterally open area. In this configuration, the regulating element has stabilizing structures in the free area beyond or above the channel shape.

One configuration of the discharge device consists in that the regulating element has an outwardly projecting balcony. The balcony preferably adjoins the channel shape and serves as a cantilever for reliably collecting the condensed water. In one configuration, the balcony is at least slightly inclined so that in a rotational position, the condensed water flows into the channel. In a further configuration, the balcony is delimited on an outer side by a terminating wall.

One configuration of the discharge device consists in that the regulating element is substantially in the form of a hollow cylinder provided with a laterally open area. In one configuration, the hollow cylinder has a circular base. In one configuration, the channel is deeper than the diameter of the base. Therefore, the enveloping surface forming the channel is larger than the enveloping surface missing due to the open area. As a result, the internal volume used for guiding and/or collecting the condensed water is larger than the portion of the internal volume given by the cylindrical basic shape which is open due to the open side area.

One configuration of the discharge device provides that the piping system comprises a plurality of hoses and/or pipes.

One configuration consists in that the air-conditioning system is configured for mounting on a roof of a movable vehicle. The movable vehicle is, for example, a caravan, a recreational vehicle, a mobile home or a boat.

### BRIEF DESCRIPTION OF THE DRAWINGS

In detail, there are a multitude of possibilities for designing and further developing the air-conditioning system according to the invention. For this purpose, reference is made on the one hand to the patent claims subordinate to the independent patent claim, and on the other hand to the following description of example embodiments in conjunction with the drawing, in which:

FIG. 1: shows a schematic representation of a caravan having an air-conditioning system,

FIG. 2: shows a spatial representation of a first configuration of a discharge device,

FIG. 3: shows a section through the discharge device of FIG. 2,

FIG. 4: shows a spatial representation of a second configuration of the discharge device,

FIG. 5: shows an enlarged detail of FIG. 4, and

FIG. 6: shows a section through the discharge device of FIG. 4.

### DETAILED DESCRIPTION OF EXAMPLE EMBODIMENTS

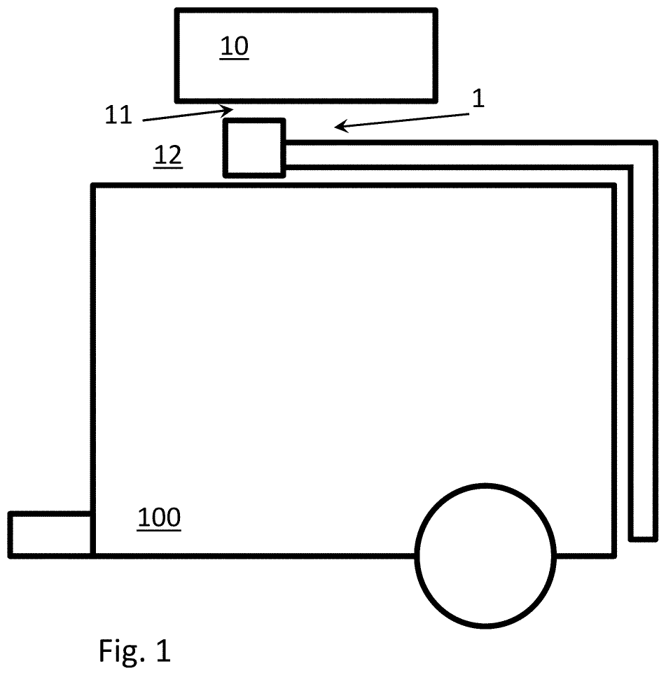

FIG. 1 schematically shows a caravan 100 as an example of a moving vehicle, on the roof of which an air-conditioning system 10—i.e. a so-called roof air-conditioning system is located. The operation of the air-conditioning system 10 causes condensed water to form in the air-conditioning system 10, which is to be drained. The discharge device 1 provided here allows switching between guiding the condensed water from the roof of the caravan 100 in the direction of the ground via the piping system indicated here, and discharging the condensed water directly onto the roof of the caravan 100 or into the outer area 12 surrounding the air-conditioning system 10. The condensed water passes into the discharge device 1 via a drip-off point 11. The drip-off point 11 is any collection point for the condensed water, at which the condensed water flows into the discharge device 1.

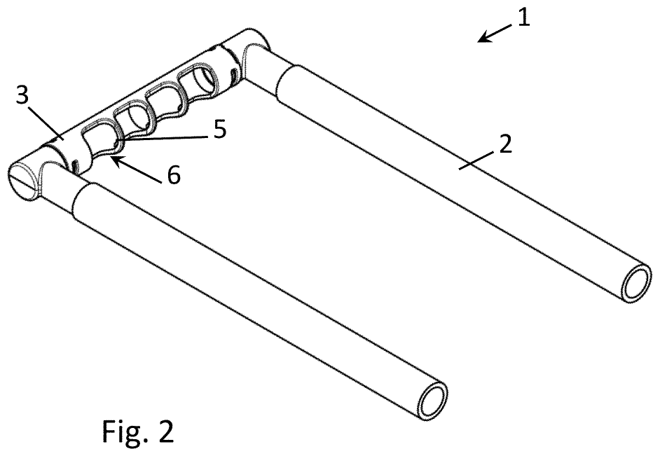

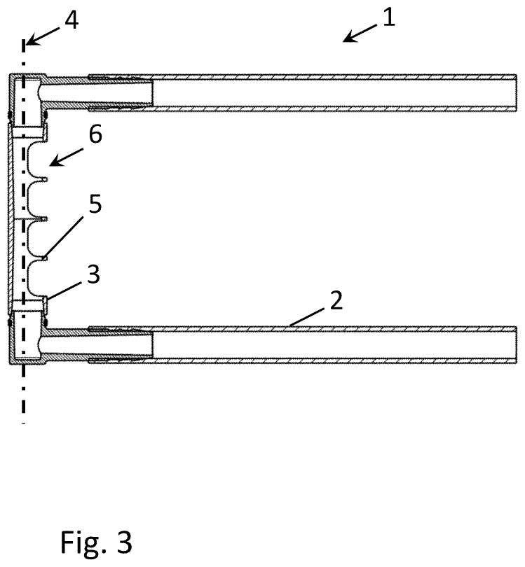

A first configuration of the discharge device 1 is shown in FIG. 2 and in FIG. 3, which will both be discussed together.

The regulating element 3 can be seen, which is located between the two lines of the piping system 2. In the installed state, the drip-off point 11, via which the condensed water flows into the discharge device 1, is preferably located above the regulating element 3 (cf. FIG. 1).

In one configuration, two regulating elements 3 are provided for an air-conditioning system and are arranged in mirror symmetry with respect to a longitudinal axis of the air-conditioning system. Therefore, the draining of the condensed water is possible at two different inclined positions of the moving vehicle.

The regulating element 3 is based on the shape of a hollow cylinder having a circular base, a laterally open area 6 being present, resulting in an overall open channel. For stabilizing the regulating element 3, three reinforcing ribs 5 are located in the laterally open area 6.

In FIG. 3 with the longitudinal axis 4 drawn in, it can be seen that the laterally open area 6 begins above the longitudinal axis 4. As a result, the internal volume enclosed by the remaining—closed—part of the regulating element 3 is larger than the volume that is also open through the open area 6 and therefore does not enclose the condensed water. Since the basic shape of the regulating element 3 here is a cylinder having a circular base, the depth of the channel is thus greater than the radius of the base. The regulating element 3 is rotatable about the longitudinal axis 4. In particular, it can be seen in FIG. 3 that a rotational position results in a free through-passage for the condensed water. This allows the condensed water to escape directly to the outer area 12 around the air-conditioning unit 10. If the regulating element 3 is rotated to another rotational position, the closed structure of the regulating element 3 forms a kind of trough in which the condensed water can flow to the piping system 2. Here, the edge areas of this trough then protrude above the height position of the longitudinal axis 4.

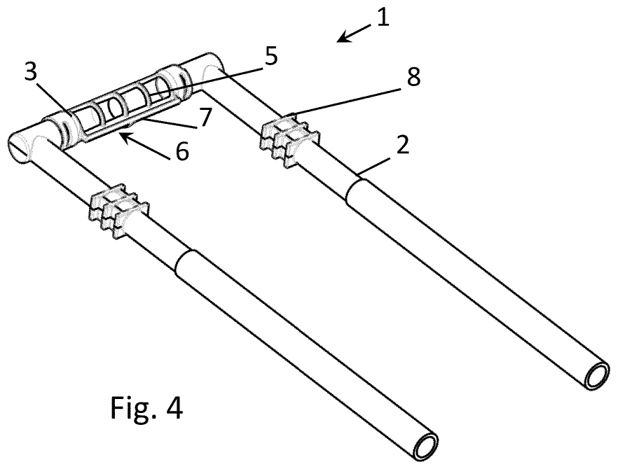

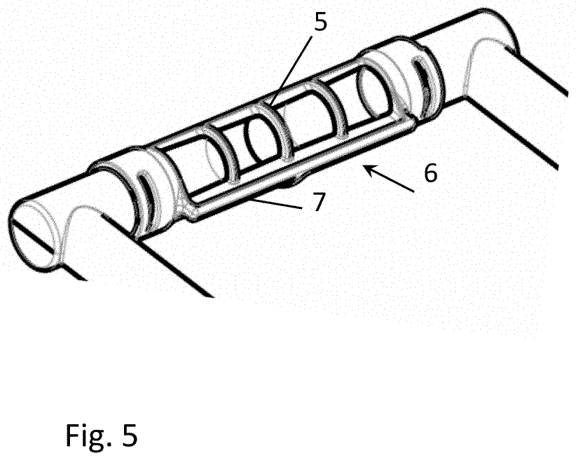

A second configuration of the discharge device is shown in FIGS. 4 to 6, which are described together. Here, only the differences to the first configuration are discussed. FIG. 5 shows an enlarged detail of FIG. 4.

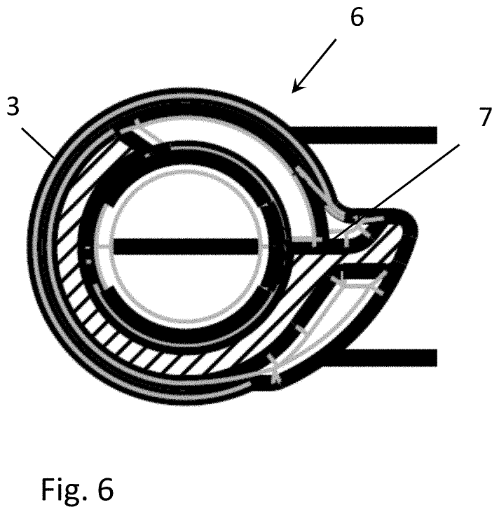

The regulating element 3 has a balcony 7 projecting radially outward, via which a larger collection surface for the condensed water is provided. The balcony 7 is located in the direction of the interior when installed in the air-conditioning system. Furthermore, a sealing structure including three sealing lips is provided on each of the two sections of the piping system 2. FIG. 6 shows a section through the regulating element 3 of FIGS. 4 and 5, the regulating element 3 being rotated such that, in the installed state, the condensed water is collected and passed on. The channel is thus open upwards in the direction of gravity. It can be seen that the balcony 7 has a rim at its end facing away from the channel, which is intended to ensure that the condensed water is collected. Furthermore, it can be seen that the channel opens above the longitudinal or central axis. If the regulating element 3 is rotated to the other rotational position in which the condensed water is to drain off, the balcony 7 also serves to drain off the condensed water safely.

1. An air-conditioning system comprising:
a discharge device for discharging condensed water from the air-conditioning system,
wherein the discharge device has a piping system for guiding the condensed water,
wherein the discharge device has a regulating element,
wherein the regulating element is configured as an open channel rotatable about a longitudinal axis between a first rotational position and a second rotational position, and
wherein the regulating element is configured and arranged such that the regulating element guides the condensed water inside the piping system in the first rotational position and establishes a continuous connection between a drip-off point for the condensed water and an outer area around the air-conditioning system in the second rotational position.

2. The air-conditioning system according to claim 1, wherein the regulating element has reinforcing ribs in a laterally open area.

3. The air-conditioning system according to claim 1, wherein the regulating element has an outwardly projecting balcony.

4. The air-conditioning system according to claim 1, wherein the regulating element is substantially in the form of a hollow cylinder provided with a laterally open area.

5. The air-conditioning system according to claim 1, wherein the air-conditioning system is configured for mounting on a roof of a movable vehicle.
